(19) United States
(12) Patent Application Publication
(10) Pub. No.: US 2002/0076241 A1
(43) Pub. Date: Jun. 20, 2002

(54) Ghosting preventing development apparatus and a reproduction machine including same

(75) Inventors: Ajay Kumar, Fairport, NY (US); John M. Wysocky, Rochester, NY (US); Eugene M. Gluszko, Rochester, NY (US); Jonathan D. Sadik, Rochester, NY (US); Beth A. Spingar, Webster, NY (US)

Correspondence Address: John E. Beck, Xerox Corporation, Xerox Square 20A, Rochester, NY, 14644, US

(73) Assignee: Xerox Corporation

(21) Appl. No.: 09/740,555

(22) Filed: Dec. 19, 2000

(51) Int. Cl. G03G 15/08

(52) U.S. Cl. 399/283; 399/273

(57) ABSTRACT

A ghosting preventing development process cartridge detachably mountable into an electrostatographic reproduction machine is provided. The ghosting preventing development process cartridge includes a housing having walls defining a partially enclosed storage chamber for storing developer material, and a development opening into the storage chamber. The ghosting preventing development process cartridge also includes a donor roll, mounted rotatably outside the chamber and near the development opening, for receiving a layer of developer material from the storage chamber, and for donating portions of such developer material layer within a development nip to image areas of an image being developed thus leaving a spent developer layer on the donor roll downstream of the development nip. The ghosting preventing development process cartridge further includes a developer material disturbing (DMD) member mounted into moving contact with the donor roll, and downstream of the development nip, for disturbing the spent layer of developer material on the donor roll, thereby preventing ghosting effects occurring in subsequently developed toner images by eliminating any ghost effects of a previously developed toner image from the spent layer of developer material on the donor roll.

### BACKGROUND

This invention relates to electrostatographic reproduction machines, and more particularly to such a machine including a ghosting preventing development apparatus.

Generally, the process of electrostatographic reproduction, as practiced in electrostatographic reproduction machines, includes charging a photoconductive member to a substantially uniform potential so as to sensitize the surface thereof. A charged portion of the photoconductive surface is exposed at an exposure station to a light image of an original document to be reproduced. Typically, an original document to be reproduced is placed in registration, either manually or by means of an automatic document handler, on a platen for such exposure.

Exposing an image of an original document as such at the exposure station, records an electrostatic latent image of the original image onto the photoconductive member. The recorded latent image is subsequently developed using a development apparatus by bringing a charged dry or liquid developer material into contact with the latent image. Two component and single component developer materials are commonly used. A typical two-component dry developer material has magnetic carrier granules with fusible toner particles adhering triobelectrically thereto. A single component dry developer material typically comprising toner particles only can also be used. The toner image formed by such development is subsequently transferred at a transfer station onto a copy sheet fed to such transfer station, and on which the toner particles image is then heated and permanently fused so as to form a “hardcopy” of the original image.

It is well known to provide a number of the elements and components, of an electrostatographic reproduction machine, in the form of a customer or user replaceable unit (CRU). Typically such units are each formed as a cartridge that can be inserted or removed from the machine frame by a customer or user. Reproduction machines such as copiers and printers ordinarily include consumable materials such as toner, volume limiting components such as a waste toner container, and life cycle limiting components such as a photoreceptor and a cleaning device. Because these elements of the copying machine or printer must be replaced frequently, they are more likely to be incorporated into a replaceable cartridge as above.

There are therefore various types and sizes of cartridges, varying from single machine element cartridges such as a toner cartridge, to all-in-one electrostatographic toner image forming and transfer process cartridges, variously using single component developer (SCD) material or two-component developer material.

Conventional Single Component Developer (SCD) material based development systems ordinarily are plagued with “ghosting problems” that show up in a currently developed toner image as a “ghost” of a previously just developed image. Development of the previously developed image reduced the mass of toner within image areas of that image, as well as reduced (as by neutralization) the level of triboelectric charge in such image areas. As a consequence, the spent toner layer left on the surface of the donor roll following such development has a non-uniform toner mass and a non-uniform charge pattern characteristized as the “residual” or “ghost” effect of the previously just developed toner image, resulting in “ghosting problems” in subsequently developed toner images.

### SUMMARY OF THE INVENTION

In accordance with the present invention, there is provided a ghosting preventing development process cartridge detachably mountable into an electrostatographic reproduction machine. The ghosting preventing development process cartridge includes a housing having walls defining a partially enclosed storage chamber for storing developer material, and a development opening into the storage chamber. The ghosting preventing development process cartridge also includes a donor roll, mounted rotatably outside the chamber and near the development opening, for receiving a layer of developer material from the storage chamber, and for donating portions of such developer material layer within a development nip to image areas of an image being developed thus leaving a spent developer layer on the donor roll downstream of the development nip. The ghosting preventing development process cartridge further includes a developer material disturbing (DMD) member mounted into moving contact with the donor roll, and downstream of the development nip, for disturbing the spent layer of developer material on the donor roll, thereby preventing ghosting effects occurring in subsequently developed toner images by eliminating any ghost effects of a previously developed toner image from the spent layer of developer material on the donor roll.

### BRIEF DESCRIPTION OF THE DRAWINGS

In the detailed description of the invention presented below, reference is made to the drawings, in which:

FIG. 1 is a front vertical illustration of an exemplary compact electrostatographic reproduction machine including a ghosting preventing development apparatus in the form of a process cartridge in accordance with the present invention;

FIG. 2 is a vertical section (front-to-back) of the ghosting preventing process cartridge of the present invention; and.

FIG. 3 is an enlarged illustration of the foam roller and donor roll assembly of the ghosting preventing process cartridge of the present invention.

### DETAILED DESCRIPTION OF THE INVENTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

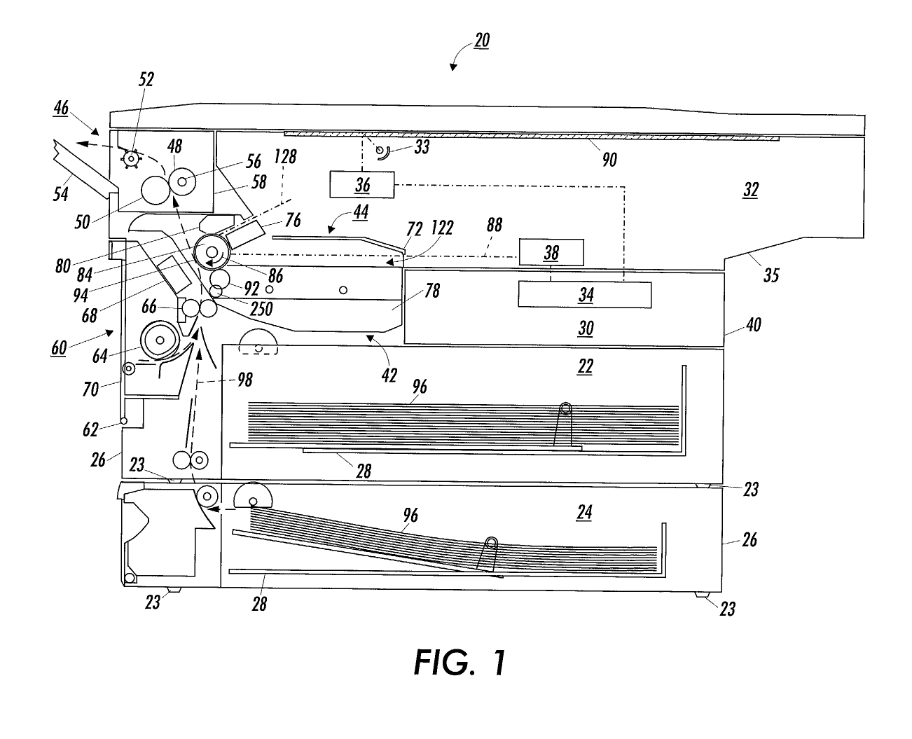

Referring now to FIG. 1, there is illustrated a frameless exemplary compact electrostatographic reproduction machine 20 comprising separately framed mutually aligning modules. As shown, the frameless machine 20 comprises at least a framed copy sheet input module (CIM) 22. Preferably, the machine 20 comprises a pair of copy sheet input modules, a main or primary module the CIM 22, and an auxiliary module the (ACIM) 24, each of which has a set of legs 23 that can support the machine 20 on a surface, therefore suitably enabling each CIM 22, 24 to form a base of the machine 20. As also shown, each copy sheet input module (CIM, ACIM) includes a module frame 26 and a copy sheet stacking and lifting cassette tray assembly 28 that is slidably movable in and out relative to the module frame 26.

The machine 20 next comprises a framed electronic control and power supply (ECS/PS) module 30, that as shown mounts onto, and is mutually aligned against the CIM 22 (which preferably is the top or only copy sheet input module). A framed latent image forming imager module 32 then mounts over and is mutually aligned against the ECS/PS module. The ECS/PS module 30 includes all controls and power supplies (not shown) for all the modules and processes of the machine 20. It also includes an image processing pipeline unit (IPP) 34 for managing and processing raw digitized images from a Raster Input Scanner (RIS) 36, and generating processed digitized images for a Raster Output Scanner (ROS) 38. As shown, the RIS 36, the ROS 38, and a light source 33, framed separately in an imager module frame 35, comprise the imager module 32. The ECS/PS module 30 also includes harnessless interconnect boards and inter-module connectors (not shown), that provide all power and logic paths to the rest of the machine modules.

An interconnect board (PWB) (not shown) connects the ECS controller and power supply boards (not shown) to the inter-module connectors., as well as locates all of the connectors to the other modules in such a manner that their mating connectors would automatically plug into the ECS/PS module during the final assembly of the machine 20. Importantly, the ECS/PS module 30 includes a module frame 40 to which the active components of the module as above are mounted, and which forms a covered portion of the machine 20, as well as locates, mutually aligns, and mounts to adjacent framed modules, such as the CIM 22 and the imager module 32.

The framed copy sheet input modules 22, 24, the ECS/PS module 30, and the imager module 32, as mounted above, define a cavity 42. The machine 20 importantly includes a customer replaceable, all-in-one CRU or process cartridge 44 that is insertably and removably mounted within the cavity 42, and in which it is mutually aligned with, and operatively connected to, the framed CIM, ECS/PS and imager modules 22, 30, 32.

As further shown, the machine 20 includes a framed fuser module 46, that is mounted above the process cartridge 44, as well as adjacent an end of the imager module 32. The fuser module 46 comprises a pair of fuser rolls 48, 50, and at least an exit roll 52 for moving an image carrying sheet through, and out of, the fuser module 46 into an output or exit tray 54. The fuser module also includes a heater lamp 56, temperature sensing means (not shown), paper path handling baffles(not shown), and a module frame 58 to which the active components of the module, as above, are mounted, and which forms a covered portion of the machine 20, as well as locates, mutually aligns, and mounts to adjacent framed modules, such as the imager module 32 and the process cartridge 44.

The machine then includes an active component framed door module 60 that is mounted pivotably at pivot point 62 to an end of the CIM 22. The door module 60 as mounted, is pivotable from a substantially closed vertical position into an open near-horizontal position in order to provide access to the process cartridge 44, as well as for jam clearance of jammed sheets being fed from the CIM 22. The Door module 60 comprises active components including a bypass feeder assembly 64, sheet registration rolls 66, toner image transfer and detack devices 68, and the fused image output or exit tray 54. The door module 60 also includes drive coupling components and electrical connectors (not shown), and importantly, a module frame 70 to which the active components of the module as above are mounted, and which forms a covered portion of the machine 20, as well as, locates, mutually aligns, and mounts to adjacent framed modules, such as the CIM 22, the process cartridge 44, and the fuser module 46.

More specifically, the machine 20 is a desktop digital copier, and each of the modules 22, 24, 30, 32, 44, 48, 60, is a high level assembly comprising a self-containing frame and active electrostatographic process components specified for sourcing, and enabled as a complete and shippable product. It is believed that some existing digital and light lens reproduction machines may contain selective electrostatographic modules that are partitioned for mounting to a machine frame, and in such a manner that they could be designed and manufactured by a supplier. However, there are no known such machines that have no separate machine frame but are comprised of framed modules that are each designed and supplied as self-standing, specable (i.e. separately specified with interface inputs and outputs), testable, and shippable module units, and that are specifically crafted and partitioned for enabling all of the critical electrostatographic functions upon a simple assembly. A unique advantage of the machine 20 of the present invention as such is that its self-standing, specable, testable, and shippable module units specifically allow for high level sourcing to a small set of module-specific skilled production suppliers. Such high level sourcing greatly optimizes the quality, the total cost, and the time of delivering of the final product, the machine 20.

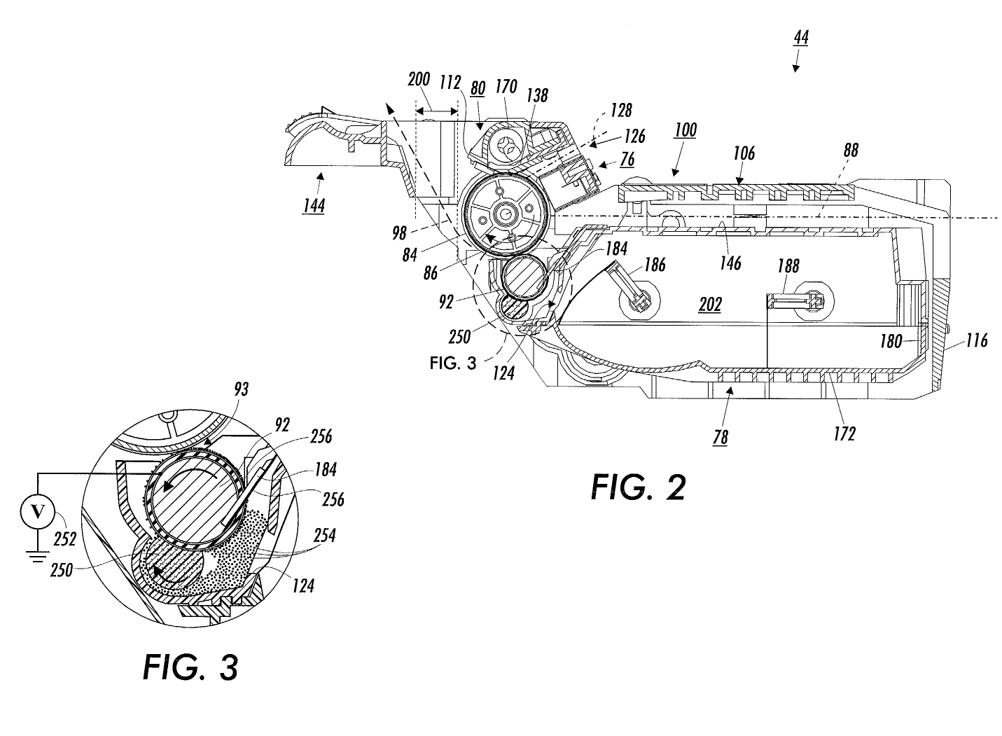

Referring now to FIGS. 1-2, the machine 20 includes a ghosting preventing development apparatus shown in the form of a CRU or process cartridge 44. The ghosting preventing cartridge 44 generally includes a housing subassembly 72, a photoreceptor subassembly 74, a charging subassembly 76, a developer subassembly 78 including a source of fresh developer material and a donor roll 92, a cleaning subassembly 80 for removing residual toner as waste toner from a surface of the photoreceptor, and a waste toner sump subassembly 82 for storing waste toner.

The developer subassembly 78 comprising the ghosting preventing CRU or process cartridge 44, is mounted within the module housing subassembly 72 as defined in part by the front end wall 116, a second side wall, and a top wall 106 of the module housing subassembly 72. The module handle 144 as attached forms a portion of the sheet or paper path 98 of the machine 20 (FIG. 1) by being spaced a distance 200 from photoreceptor 84 in the raised rear end 112 of the module housing 100. The photoreceptor or drum 84 is located within the raised rear end 112 and is rotatable in the direction of the arrow 86.

The charging subassembly 76 is mounted within the top wall 106 and includes a slit defining part of the second light path 126 for erase light 128 (FIG. 1) to pass to the photoreceptor 84. Upstream of the charging subassembly 76, the cleaning subassembly 80, including the cleaning blade 138 and the waste toner removing auger 170, is mounted within the raised rear end 112, and into cleaning contact with the photoreceptor 84. As further shown, the top wall 106 of the module housing 100 is spaced from the top 146 of the developer subassembly 78, thus defining the part of first light path 122 (FIG. 1) for the exposure light 88 from the ROS 38 (FIG. 1). The first light path 122 is located so as to be incident onto the photoreceptor at a point downstream of the charging subassembly 76.

Referring to FIGS. 1-3, the front 180, top 146, and bottom member 172 of the developer subassembly define a chamber 202, having an opening 204, for containing developer material 254. The first and second agitators 186, 188 are shown within the chamber 202 for mixing and moving developer material towards the opening 204. A developer material biasing device 184 and a charge trim and metering blade 256 are mounted at the opening 204. As also shown, the magnetic developer or donor roll 92 is mounted near the opening 204 for receiving charged and metered developer material 254 from such opening, and for transporting such developer material into a development relationship with the photoreceptor 84.

Importantly in accordance with the present invention, the ghosting preventing CRU or cartridge 44 further includes a development material disturbing assembly 250 for preventing “ghosting” by disturbing a mass, and charge values, of a layer of residual developer material left on the donor roll 92 following image development within a development nip 93 formed by the donor roll 92 and the photoreceptor 84. The developer material 254 preferably is toner particles only, or what is referred to as Single Component Developer (SCD).

As pointed out above, conventional Single Component Developer (SCD) material based development systems ordinarily are plagued with “ghosting problems” that show up in a currently developed toner image as a “ghost” of a previously just developed image. Development of the previously developed image reduced the mass of toner within image areas of that image, as well as reduced (as by neutralization) the level of triboelectric charge in such image areas. As a consequence, the spent toner layer left on the surface of the donor roll following such development has a non-uniform toner mass and a non-uniform charge pattern characteristized as the “residual” or “ghost” effect of the previously just developed toner image, resulting in “ghosting problems” in subsequently developed toner images.

In general, such “ghosting problems” are believed to be due to the variations in the mass of toner left on the donor roll (TMAD) following image development within the nip 93, and to variations in “tribo-electric” charge values of such toner on the donor roll 92. Donor roll 92 which rotates in the counter clockwise direction as shown has a first velocity, and is preferably made of bare-aluminum, or has a bare-Aluminum coating, and is biased as shown by a bias source 252 of about 250 volts. Bare aluminum is aluminum that has been cleaned, for example, by etching the surface or using solutions and solvents to remove any surface layers and/or surface contaminants.

The development material disturbing assembly 250 is preferably a foam roller, and is mounted as shown into significant rotational interference and frictional contact with the donor roll 92. The foam roller 250 is preferably made from Polyester/Polyurethane foam having a 6 pound per cubic foot density and about 100 to 110 pores per inch. It is mounted and driven so as to rotate at a second velocity, and in a clockwise direction as shown. In accordance with an aspect of the present invention, the second velocity of the foam roller 250 is greater than the first velocity of the donor roll 92, thus resulting in frictional and tribo-electric charging of the surface of the bare-aluminum donor roll 92.

Such charging enhances the ability of the donor roll 92 to pickup developer material 254 from the sump 202. By rotating into frictional contact with the donor roll 92, the foam roller 250 rubs, and disturbs any residual toner left on the donor roll 92 following image development within the development nip 93. Rubbing and disturbing the residual toner as such effectively eliminates any “residual image” effect or “ghosting” effects (both in terms of a toner mass effect and a tribo-ectric charge effect) that are left thereon from the previous image. The foam roller 250 eliminates such “ghosting” effects by “disturbing” the toner-mass and charge levels or values of image and non-image areas in the layer of residual or spent developer material on the donor roll 92 from the previously developed image.

The foam roller 250 by tribo-ectrically and uniformly affecting the charge on the bare-aluminum donor roll 92, also helps the loading downstream, of “fresh-toner” 254 from the sump 202 onto the donor roll 92. As shown, a fresh toner charging and metering blade 256 is provided for charging and metering the toner 254 to form a layer thereof on the donor roll 92 before such layer enters the development nip 93.

Referring again to FIG. 1, operation of an imaging cycle of the machine 20 using the ghosting preventing CRU or process cartridge 44 generally, can be briefly described as follows. Initially, a photoreceptor in the form of a photoconductive drum 84 of the ghosting preventing customer replaceable unit (CRU) or process cartridge 44, rotating in the direction of the arrow 86, is charged by the charging subassembly 76. The charged portion of the drum is then transported to an imaging/exposing light 88 from the ROS 38 which forms a latent image on the drum 84, corresponding to an image of a document positioned on a platen 90, via the imager module 32. It will also be understood that the imager module 32 can easily be changed from a digital scanning module to a light lens imaging module.

The portion of the drum 84 bearing a latent image is then rotated to the developer subassembly 78 where the latent image is developed with developer material such as with charged single component magnetic toner using a magnetic developer or donor roller 92 of the process cartridge 44. The developed image on the drum 84 is then rotated to a near vertical transfer point 94 where the toner image is transferred to a copy sheet substrate 96 fed from the CIM 22 or ACIM 24 along a copy sheet or substrate path 98. In this case, the detack device 68 of the door module 60 is provided for charging the back of the copy sheet substrate (not shown) at the transfer point 94, in order to attract the charged toner image from the photoconductive drum 84 onto the copy sheet substrate.

The copy sheet substrate with the transferred toner image thereon, is then directed to the fuser module 46, where the heated fuser roll 48 and pressure roll 50 rotatably cooperate to heat, fuse and fix the toner image onto the copy sheet substrate. The copy sheet substrate then, as is well known, may be selectively transported to the output tray 54 or to another post-fusing operation.

The portion of the drum 84 from which the developed toner image was transferred is then advanced to the cleaning subassembly 80 where residual toner and residual charge on the drum 84 are removed therefrom. In accordance with the present invention, before the imaging cycle of the machine 20 using the drum 84 can then be repeated for forming and transferring another toner image, (as the cleaned portion again comes under the charging subassembly 76), a mass, and a charge level, of a layer of residual or spent developer material left on the surface of the donor roll 92 is rubbed, and disturbed so as to effectively eliminate “ghosting effects” therein from the previously developed toner image. As such subsequent toner images can be produced without “ghosting problems”.

As can be seen, there has been provided a ghosting preventing development process cartridge detachably mountable into an electrostatographic reproduction machine. The ghosting preventing development process cartridge includes a housing having walls defining a partially enclosed storage chamber for storing developer material, and a development opening into the storage chamber. The ghosting preventing development process cartridge also includes a donor roll, mounted rotatably outside the chamber and near the development opening, for receiving a layer of developer material from the storage chamber, and for donating portions of such developer material layer within a development nip to image areas of an image being developed thus leaving a spent developer layer on the donor roll downstream of the development nip. The ghosting preventing development process cartridge further includes a developer material disturbing (DMD) member mounted into moving contact with the donor roll, and downstream of the development nip, for disturbing the spent layer of developer material on the donor roll, thereby preventing ghosting effects occurring in subsequently developed toner images by eliminating any ghost effects of a previously developed toner image from the spent layer of developer material on the donor roll.

While the embodiment of the present invention disclosed herein is preferred, it will be appreciated from this teaching that various alternative, modifications, variations or improvements therein may be made by those skilled in the art, which are intended to be encompassed by the following claims:

What is claimed is:

1. A ghosting preventing development process cartridge detachably mountable into an electrostatographic reproduction machine, the ghosting preventing development process cartridge comprising:
(a) a housing having walls defining a partially enclosed storage chamber for storing developer material, and a development opening into said storage chamber;
(b) a donor roll, mounted rotatably outside said chamber and near said development opening, for receiving a layer of developer material from said storage chamber, and for donating portions of such developer material layer within a development nip to image areas of an image being developed thus leaving a spent developer layer on said donor roll downstream of the development nip; and
(c) a developer material disturbing (DMD) member mounted into moving contact with said donor roll, and downstream of said development nip, for disturbing the spent layer of developer material on said donor roll, thereby preventing ghosting effects occurring in subsequently developed toner images by eliminating any ghost effects of a previously developed toner image from the spent layer of developer material on said donor roll.

2. The ghosting preventing development process cartridge of claim 1, including a charging and metering blade mounted against said donor roll, downstream of said DMD member, for controlling a thickness of the layer of developer material on said donor roll.

3. The ghosting preventing development process cartridge of claim 1, wherein said DMD member comprises a rotatable roller.

4. The ghosting preventing development process cartridge of claim 1, wherein said DMD member is located outside said development opening.

5. The ghosting preventing development process cartridge of claim 1, wherein said DMD member comprises a rotatable foam roller.

6. The ghosting preventing development process cartridge of claim 5, wherein said rotatable foam roller is made of a Polyester/Polyurethane foam.

7. The ghosting preventing development process cartridge of claim 5, wherein said rotatable foam roller has a velocity greater than a velocity of said donor roll.

8. The ghosting preventing development process cartridge of claim 5, wherein said foam roller has a porosity of about 100 to 110 pores per inch.

9. The ghosting preventing development process cartridge of claim 5, wherein said foam roller has a density of six pound per cubic foot.

10. An electrostatographic reproduction machine comprising:
(a) a frame, and a moveable image bearing member having an image bearing surface;
(b) means for forming latent images on said image bearing surface; and
(c) a ghosting preventing development process cartridge detachably mountable into said frame of the electrostatographic reproduction machine, said ghosting preventing development process cartridge including:
(i) a housing having walls defining a partially enclosed storage chamber for storing developer material, and a development opening into said storage chamber;
(ii) a development roll assembly including a donor roll, mounted rotatably outside said chamber and near said development opening, for receiving a layer of developer material from said storage chamber, and for donating portions of such developer material layer within a development nip to image areas of an image being developed thus leaving a spent developer layer on said donor roll downstream of the development nip; and
(iii) a developer material disturbing (DMD) member mounted into moving contact with said donor roll, and downstream of said development nip, for disturbing the spent layer of developer material on said donor roll, thereby preventing ghosting effects occurring in subsequently developed toner images by eliminating any ghost effects of a previously developed toner image from the spent layer of developer material on said donor roll.

11. The electrostatographic reproduction machine of claim 10, wherein said DMD member comprises a rotatable foam roller.

12. The electrostatographic reproduction machine of claim 10, wherein said rotatable foam roller is made of a Polyester/Polyurethane foam.

13. The electrostatographic reproduction machine of claim 10, wherein said rotatable foam roller has a velocity greater than a velocity of said donor roll.

14. The electrostatographic reproduction machine of claim 10, wherein said foam roller has a porosity of about 100 to 110 pores per inch.

15. The electrostatographic reproduction machine of claim 10, wherein said foam roller has a density of six pound per cubic foot.
